(19) United States
(12) Patent Application Publication
(10) Pub. No.: US 2022/0221486 A1
(43) Pub. Date: Jul. 14, 2022

(54) Stillness Measurement Apparatus, System, and Method

(71) Applicant: Stillaton, Inc., Bellevue, WA (US)

(72) Inventors: Philip Lorenzo, Bellevue, WA (US); Vadim Pougatchev, Poulsbo, WA (US); Trevor Sunderland, Vaughn, WA (US)

(73) Assignee: Stillaton, Inc., Bellevue, WA (US)

(21) Appl. No.: 17/573,513

(22) Filed: Jan. 11, 2022

Related U.S. Application Data
(60) Provisional application No. 63/136,425, filed on Jan. 12, 2021.

(51) Int. Cl. G01P 13/00; G01P 15/18; G01C 19/5712

(52) U.S. Cl. CPC G01P 13/00; G01C 19/5712; G01P 15/18

(57) ABSTRACT

One or more methods, apparatuses, and/or systems to collect stillness measurements during a stillness event, where the stillness measurements are based on a stillness metric associated with a stillness event and to store a stillness score for a participant in the stillness event that is based on the one or more stillness measurements.

### CLAIM OF PRIORITY

This application claims the benefit of U.S. Provisional Application No. 63/136,425, filed Jan. 12, 2021, entitled “Stillness Measurement Apparatus, System, and Method.”

### FIELD

At least one embodiment pertains to measuring stillness in humans. For example, at least one embodiment pertains to processors or computer systems used to execute a method to measure and score stillness of a human using a stillness measurement apparatus.

### BACKGROUND

Wearable computer devices can detect and measure a wide range of physiological information for humans, such as heart rate, temperature, and motion, such as steps, distance traveled, and the like, using sensors, including accelerometers and or gyroscopes.

Only a relative handful of research articles are squarely addressed to measuring physical stillness, such as in the context of autism spectrum disorder, attention deficit hyperactivity disorder, and meditation, including the development of a “physical stillness index” associated with “happiness scores” during “Chan Ding” meditation practice.

In the Chan Ding research, “The Evaluation of Physical Stillness with Wearable Chest and Arm Accelerometer during Chan Ding Practice”, Kang-Ming Chang, Yu-Teng Chun, Sih-Huei Chen, Luo Lu, Hsiao-Ting Jannis Su, published 2016 Jul. 20, physical stillness was measured using three wireless accelerometers, two strapped to upper arms and a third strapped to a test subject's chest. In the Chan Ding research, the accelerometers had a sampling frequency of 500 Hz; test subjects were asked to engage in specific movements practiced during Chan Ding; test subjects were asked to answer a “Chinese Happiness Inventory” survey to assess happiness; and test subjects were divided into groups based on experience. In the Chan Ding research, test subjects were asked to engage in four movement types over 30 minutes, as follows: anterior-posterior, left-to-right, hand movement, and no-swaying with natural breathing. In the Chan Ding research, a mean acceleration value for each of three movement axis was subtracted from an instantaneous acceleration value and output from the three different accelerometers were compared to determine which position had a higher sensitivity to detect the types of bodily motion that were studied. The Chan Ding research concluded that “the accelerometer worn on the upper arm had a higher sensitivity to detect body movement”. Chan Ding, p. 6. The Chan Ding research did not identify when the accelerometers were turned on or how the test data were filtered, with data only being presented for the time period when a test subject was in a desired posture; e.g. the Chan Ding research did not identify whether data from period when the test subjects were assuming the desired posture were excluded.

A similar study to the Chan Ding research is found in “Wearable Sensors for Measuring Movement in Short Sessions of Mindfulness Sitting Meditation: A Pilot Study”, in Journal of Healthcare Engineering, Volume 2018, Published 2018-05-07, by Victor H. Rodriguez, Carlos T. Medrano, and Inmaculada Plaza. This study looked at anterior-posterior movement and left-right movement, evaluated the sensitivity of accelerometer placement (glasses worn on the head, infraclavicular region (near the shoulder), sternum, left side of lumbar region, and thumb), different supports used by test subjects, discussed use of low-pass and moving average filters to reduce noise and remove any dynamic component, and determination of a global measure of test subject's change of position (not actual posture or position) based on difference between maximum and minimum signal values.

Physical stillness is not the absence of motion, because even at rest a living mammal has a pulse and breathes, which produces motion.

Competitions in which contestants compete to demonstrate stillness are not yet practiced.

### BRIEF DESCRIPTION OF THE DRAWINGS

Various embodiments in accordance with the present disclosure will be described with reference to the drawings, in which:

FIG. 1 is a network and device diagram illustrating an example of a stillness comparison server, a stillness comparison server datastore, a user mobile device, a stillness sensor device, and a network, according to at least one embodiment;

FIG. 2 is a functional block diagram illustrating an example of the stillness comparison server computer device of FIG. 1, according to at least one embodiment;

FIG. 3 is a functional block diagram illustrating an example of a stillness comparison server computer device datastore, according to at least one embodiment;

FIG. 4 is a flow diagram illustrating an example of a method performed by a stillness comparison server module, according to at least one embodiment;

FIG. 5A is a first part of a flow diagram illustrating an example of a method performed by a stillness measurement module, according to at least one embodiment;

FIG. 5B is a second part of a flow diagram illustrating an example of a method performed by a stillness measurement module, according to at least one embodiment;

FIG. 6 is a flow diagram illustrating an example of a method performed by a stillness score module, according to at least one embodiment;

FIG. 7 illustrates an example of a stillness sensor device, according to at least one embodiment;

FIG. 8 illustrates an example of a portion of the stillness sensor device of FIG. 7 in an exploded format to show components thereof, according to at least one embodiment;

FIG. 9A illustrates a graph of a sample of unfiltered sensor data, according to at least one embodiment;

FIG. 9B illustrates a graph of a sample of filtered sensor data, according to at least one embodiment;

FIG. 10 illustrates examples of movements of one or more sensors according to at least one embodiment; and

FIG. 11 illustrates an example environment in which various embodiments can be implemented.

### DETAILED DESCRIPTION

In addition to other locations, defined terms may be found at the end of this Detailed Description.

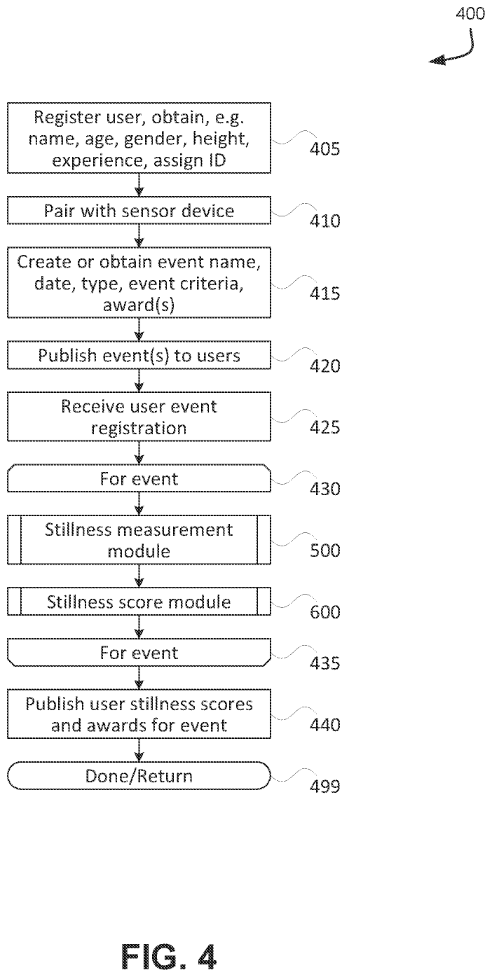

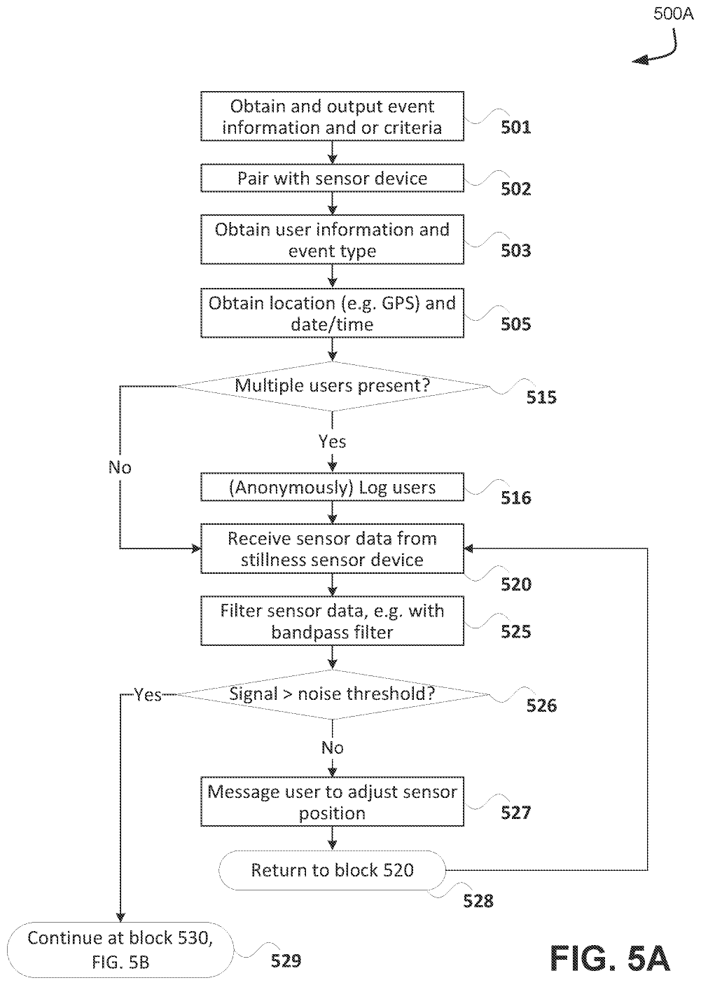

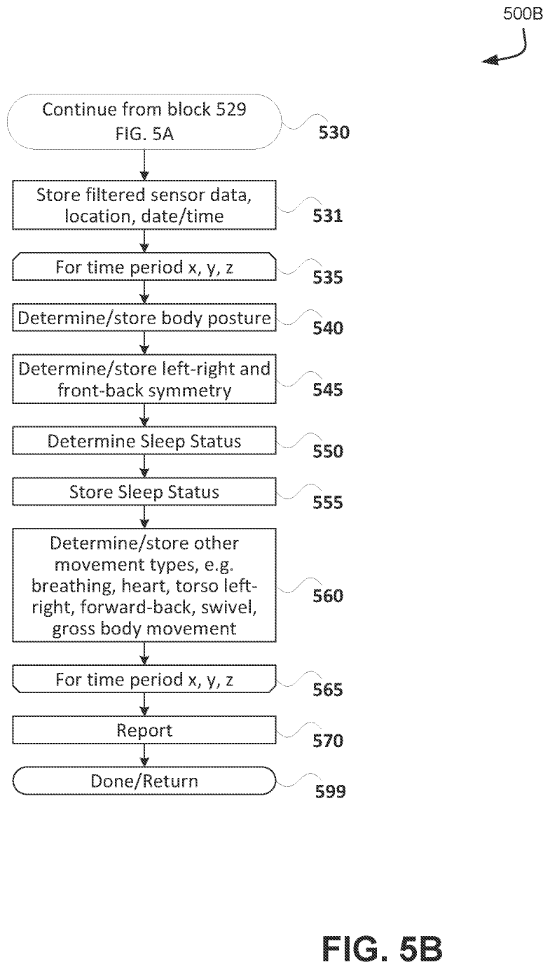

The present disclosure relates to an apparatus, system, and one or more methods performed using one or more computer device apparatuses, such as stillness comparison server 200, user mobile device 110, and stillness sensor device 105, in accordance with at least one embodiment. In at least one embodiment, stillness comparison server 200 may perform a stillness comparison server module 400 (as described herein at least in connection with FIG. 4) to create stillness events, to obtain stillness measurements obtained during stillness events from a stillness measurement module 500, (as described herein at least in connection with FIG. 5A and FIG. 5B) to compare the stillness measurements, to develop one or more stillness scores with respect to the stillness measurements, and to publish the stillness scores and awards. In at least one embodiment, stillness sensor device 105 may obtain stillness measurements from participants during stillness events and may report this information to user mobile device 110 and or to stillness comparison server 200. In at least one embodiment, user mobile device 110 and or stillness comparison server 200 may filter and store the sensor data, and, across one or more time periods, may determine a body posture, a left-right symmetry, whether a user (or participant) is awake, and determine other movement types.

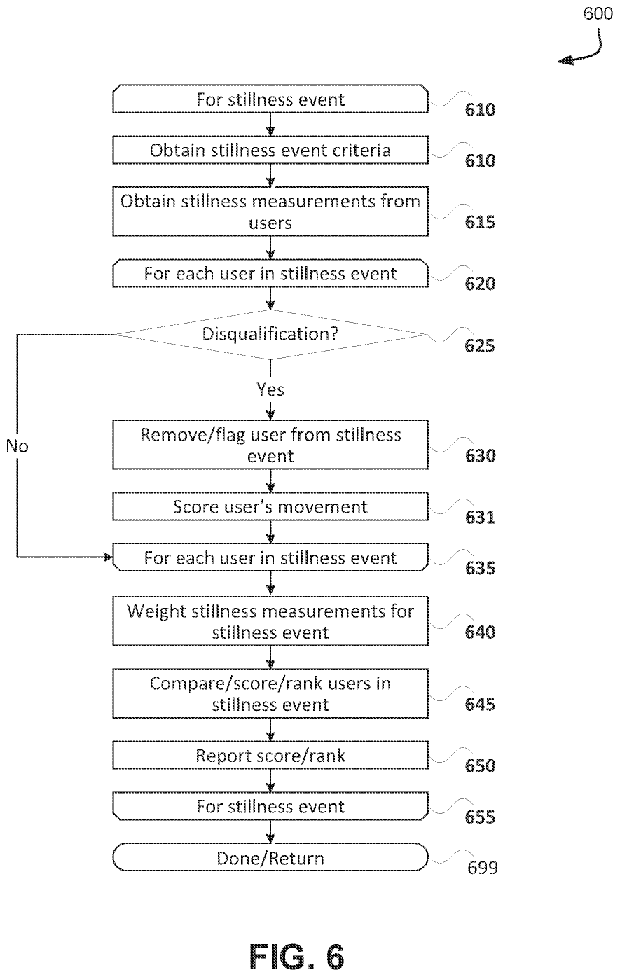

In at least one embodiment, stillness comparison server 200, user mobile device apparatus 110, and stillness sensor device 105 may include one or more hardware acceleration modules to accelerate the performance of modules by the apparatuses. In at least one embodiment, stillness comparison server 200 may include one or more hardware acceleration modules that may be used to accelerate execution of stillness comparison server module 400 and/or may include one or more hardware acceleration modules that may be used to accelerate execution of stillness score module 600 (as described herein at least in connection with FIG. 6). In at least one embodiment, user mobile device 110 may include one or more hardware acceleration modules that may be used to accelerate execution of stillness measurement module 500. In at least one embodiment, stillness sensor device 105 may include one or more hardware acceleration modules that may be used to obtain and process stillness measurements, using systems and methods such as those described herein.

In at least one embodiment, stillness comparison server 200, user mobile device apparatus 110, and stillness sensor device 105 may setup stillness events, may collect stillness measurements from participants during stillness events, may determine body posture, left-right, and front-back symmetry for participants in the stillness events, may develop stillness scores for users in the stillness events based on the stillness measurements, and/or may report the scores and rank of participants in the stillness events, using systems and methods such as those described herein.

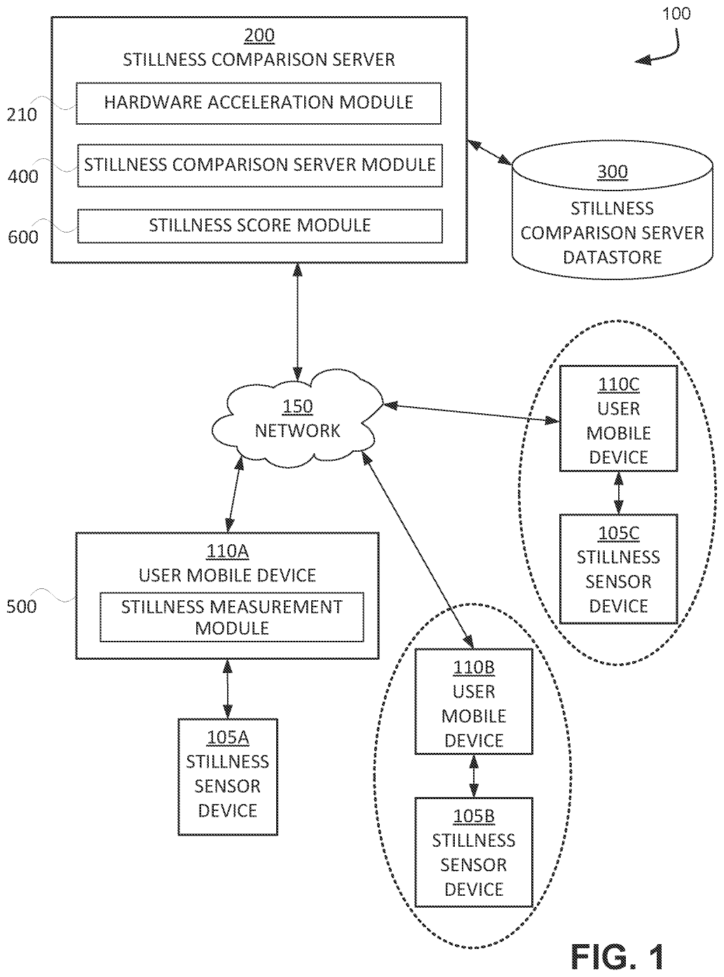

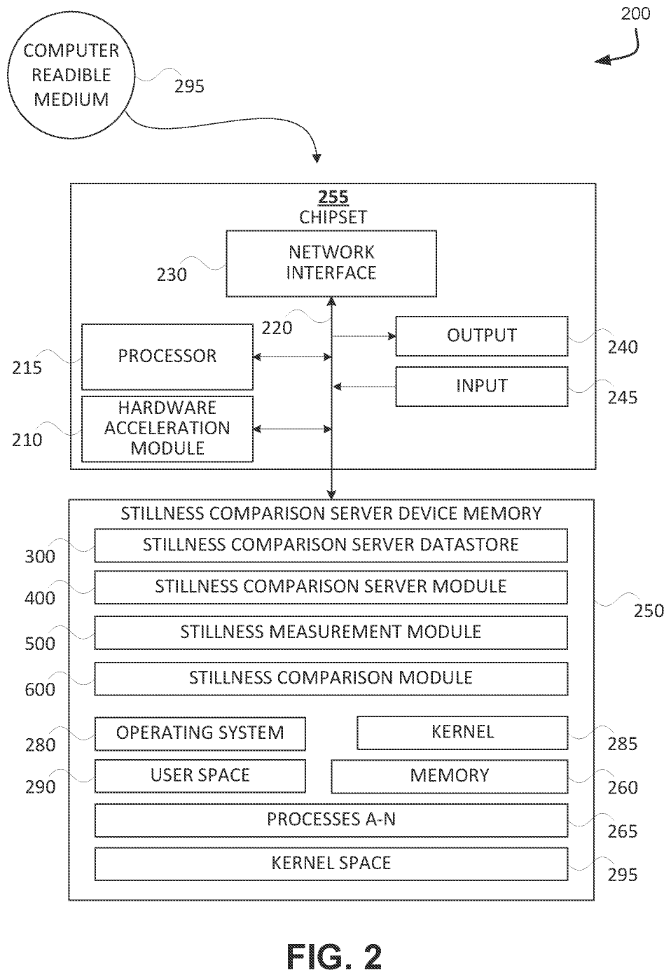

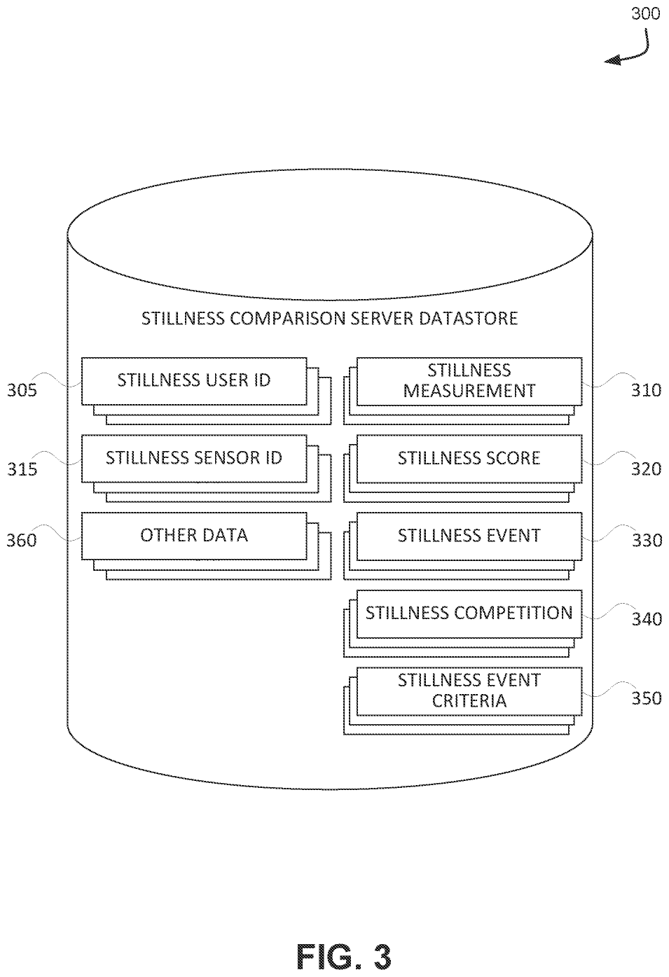

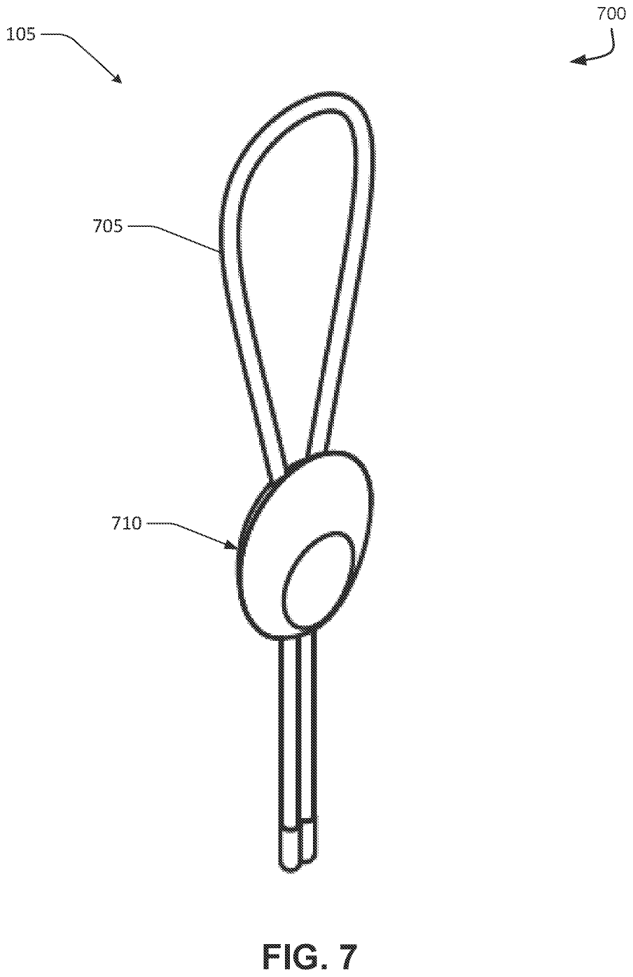

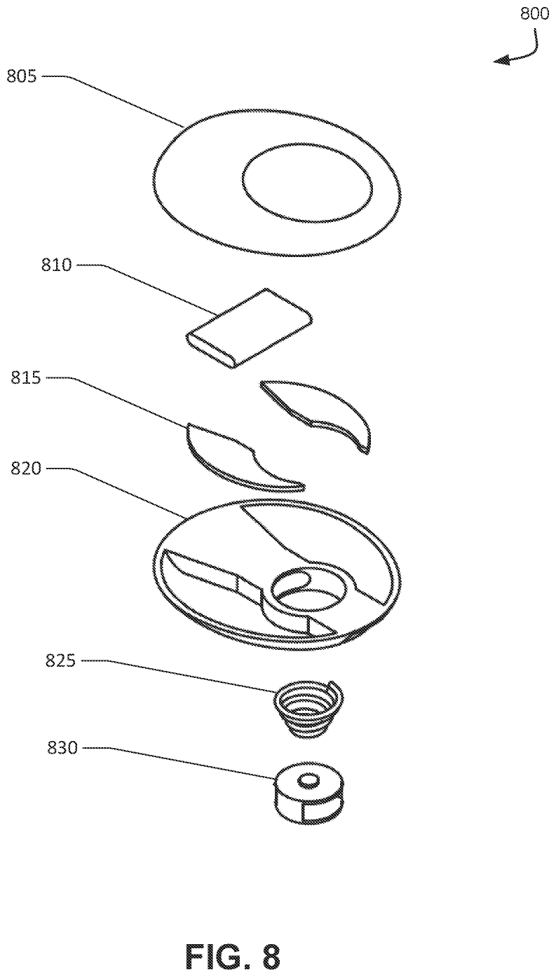

FIG. 1 is a network and device diagram 100 illustrating an example of stillness comparison server 200 (described herein at least in connection with FIG. 2), comprising hardware acceleration module 210 (described herein at least in connection with FIG. 2), stillness comparison server module 400 (described herein at least in connection with FIG. 4), and stillness score module 600 (described herein at least in connection with FIG. 6). FIG. 1 further illustrates an example of stillness comparison server datastore 300 (described herein at least in connection with FIG. 3). FIG. 1 further illustrates an example of user mobile device 110 comprising stillness measurement module 500 (described herein at least in connection with FIG. 5). FIG. 1 further illustrates an example of stillness sensor device 105 and network 150, according to at least one embodiment. FIG. 7 illustrates an example of stillness sensor device 105. FIG. 8 illustrates an example of stillness sensor device 105 in an exploded form, to illustrate potential components thereof.

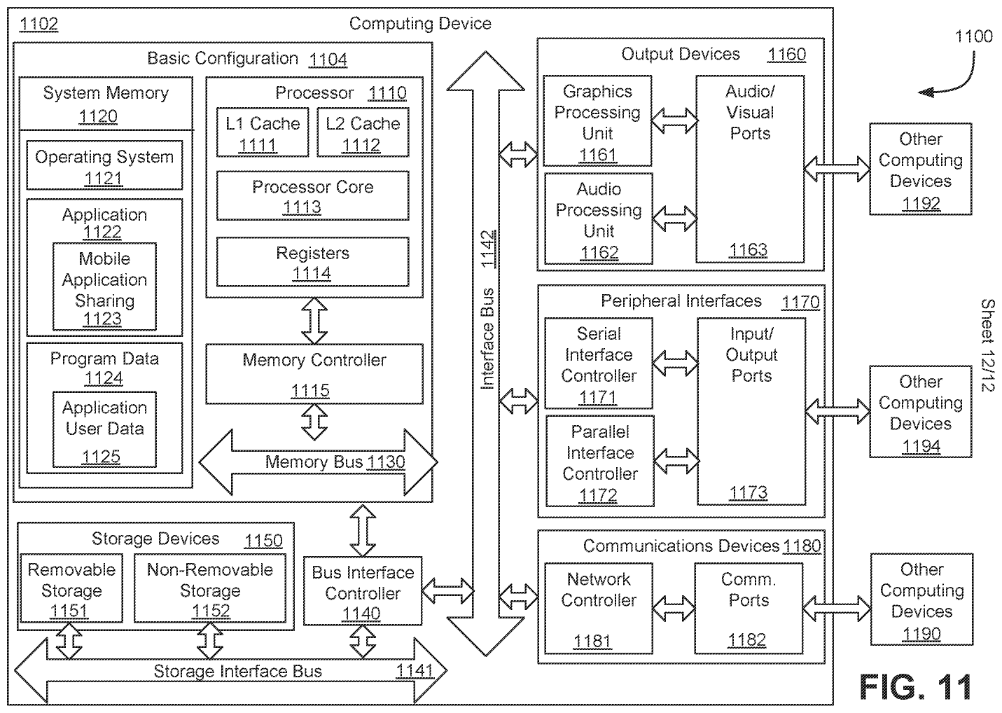

In at least one embodiment, stillness comparison server 200 is a computing device such as those described herein (e.g., computing device 1102 described herein at least in connection with FIG. 11). In at least one embodiment, user mobile device 110 is a computing device such as those described herein (e.g., computing device 1102 described herein at least in connection with FIG. 11). In at least one embodiment, stillness comparison server 200 and user mobile device 110 are understood herein to be similar computer devices. In at least one embodiment, a principal difference between stillness comparison server 200 and user mobile device 110 may be a form factor. In at least one embodiment, stillness comparison server 200 may be a server computer device, such as a desktop, laptop, rack-mounted server computer or the like, generally configured to be a server, with less focus on user input-output physically at the computing device. In at least one embodiment, user mobile device 110 may be a mobile or portable computer device, such as a mobile phone, a laptop, a tablet computer, or the like, with greater focus on user input-output at the computing device. As may be contemplated, although a computing device such as stillness comparison server 200 may be described as a “server” computing device and a mobile device such as user mobile device 110 may be described as a “user”, “mobile” or “portable” computing device, apart from form factors and user input, physical and logical descriptions of stillness comparison server 200 and stillness comparison server datastore 300 herein may be applied to user mobile device 110.

In at least one embodiment, stillness comparison server 200 and stillness comparison server module 400 therein may be used to register users or participants, for example, to allow registered participants to enroll in stillness events, to create stillness events, obtain stillness event criteria, to publish stillness events, and to enroll participants in events. In at least one embodiment, stillness comparison server 200 and stillness comparison server module 400 may further perform and or receive data from stillness measurement module 500 and stillness sensor device 105, such as from participants enrolled in events. In at least one embodiment, data from stillness measurement module 500 and stillness sensor device 105 may comprise stillness measurements and or results obtained from processing the stillness measurements, such as body postures, left-right and front-back symmetry, whether participants fell asleep, and the like. In at least one embodiment, stillness comparison server 200 may perform stillness score module 600, to determine stillness scores and ranks according to event criteria, whether participants were disqualified from an event, such as due to falling asleep.

In at least one embodiment, a participant (not illustrated in FIG. 1) may use stillness sensor device 105 to obtain stillness measurements of themselves, both generally and during stillness events. In at least one embodiment, a participant may pair user mobile device 110 with stillness sensor device 105 and may obtain and process stillness measurements from stillness sensor device 105, such as with stillness measurement module 500. In at least one embodiment, stillness measurement module 500 may obtain and output stillness event criteria, identify a location of a first participant and or identify the presence of other participants enrolled in events in temporal or physical proximity to the first participant. In at least one embodiment, for example, a stillness event may require, weight, rank or score participants differently depending on whether the participant was present with others. In at least one embodiment, stillness measurement module 500 may receive sensor data from stillness sensor device, may filter and store the sensor data, for one or more time periods which may be relevant to an event, may determine and store body posture, left-right and front-back symmetry, whether the participant is aware or asleep, and other movement types which may be determinable based on the sensor data. In at least one embodiment, stillness measurement module 500 may report the obtained data and/or determined movement types and participant status back to, for example, stillness comparison server 200 and modules thereof, for ranking, scoring, and other purposes.

In at least one embodiment, stillness comparison server 200 is illustrated as connecting to stillness comparison server datastore 300. As may be contemplated, although stillness comparison server datastore 300 is described further at least in connection with FIG. 3, stillness comparison datastore 300 should be understood as a datastore used by stillness comparison server 200.

In at least one embodiment, network 150 may comprise computers, network connections among the computers, and software routines to enable communication between the computers over the network connections such as those described herein. Examples of Network 150 comprise an Ethernet network, the Internet, and/or a wireless network, such as a GSM, TDMA, CDMA, EDGE, HSPA, LTE or other network provided by a wireless service provider. Connection to Network 150 may be via a Wi-Fi connection. In at least one embodiment, a plurality of networks may be involved in a communication session between the devices described herein. In at least one embodiment, connection to network 150 may require that computers execute software routines which enable, for example, the seven layers of the OSI model of computer networking or equivalent in a wireless phone network.

FIG. 2 is a functional block diagram illustrating an example of stillness comparison server 200, incorporated with teachings of the present disclosure, according to at least one embodiment. In at least one embodiment, stillness comparison server 200 may include chipset 255. In at least one embodiment, chipset 255 may include processor 215, input/output (I/O) port(s) and peripheral devices, such as output 240 and input 245, and network interface 230, and computer device memory 250, all interconnected via bus 220. In at least one embodiment, network interface 230 may be utilized to form connections with network 150, with stillness comparison server datastore 300, or to form device-to-device connections with other computers.

In at least one embodiment, chipset 255 may include communication components and/or paths, e.g., buses 220, that couple processor 215 to peripheral devices, such as, for example, output 240 and input 245, which may be connected via I/O ports. Processor 215 may include one or more execution cores (CPUs). In at least one embodiment, for example, chipset 255 may include a peripheral controller hub (PCH) (not shown). In at least one embodiment, for example, chipset 255 may include a sensors hub (not shown). In at least one embodiment, input 245 and output 240 may include user interface device(s) including, but not limited to, a display, a touch-screen display, printer, keypad, keyboard, etc., sensor(s) including accelerometer, global positioning system (GPS), gyroscope, etc., communication logic, wired and/or wireless, storage device(s) including hard disk drives, solid-state drives, removable storage media, etc. In at least one embodiment, I/O ports for input 245 and output 240 may be configured to transmit and/or receive commands and/or data according to one or more communications protocols. In at least one embodiment, for example, one or more of the I/O ports may comply and/or be compatible with a universal serial bus (USB) protocol, peripheral component interconnect (PCI) protocol (e.g., PCI express (PCIe)), or the like.

In at least one embodiment, hardware acceleration module 210 may provide hardware acceleration of various functions otherwise performed by, for example, stillness comparison server module 400, stillness score module 600, and/or, such as in the case of user mobile device 110, stillness measurement module 500. In at least one embodiment, a similar component to hardware acceleration module 210 may be in stillness sensor device 105. In at least one embodiment, a hardware acceleration module may be provided by, for example, an “Integrated Performance Primitives” software library by Intel™ Corporation. In at least one embodiment, a hardware acceleration module may be executed by an Intel™ chip or may be executed by another compatible chip. In at least one embodiment, a hardware acceleration module may implement, for example, a library of programming functions involved with real time computer vision (for example, OpenCV). In at least one embodiment, a library of programmable functions such as OpenCV may include application areas including, but not limited to, 2D and 3D feature toolkits, egomotion estimation, facial recognition, gesture recognition, human-computer interaction, mobile robotics, motion understanding, object identification, segmentation and recognition, stereopsis stereo vision (including depth perception from two cameras), structure from motion, motion tracking, and augmented reality. In at least one embodiment, a library of programmable functions such as OpenCV may include a statistical machine learning library including, but not limited to, boosting, decision tree learning, gradient boosting trees, expectation-maximization algorithms, k-nearest neighbor algorithm, naïve Bayes classifier, artificial neural networks, random forest, and a support vector machine. In at least one embodiment, hardware acceleration module 210 may be a field programmable gate array (“FPGA”) which may include one or more gate arrays that are configured with a bit stream to embody the logic of the hardware accelerated function (equivalent to the logic provided by the executable instructions of a software embodiment of the function). In at least one embodiment, hardware acceleration module 210 may include components of computer device memory 250 and/or components for supporting computer device memory 250.

In at least one embodiment, computer device memory 250 may comprise a random-access memory (“RAM”), a read-only memory (“ROM”), and/or a permanent mass storage device, such as a disk drive or SDRAM (synchronous dynamic random-access memory). In at least one embodiment, computer device memory 250 may store program code for modules and/or software routines, such as, for example, hardware acceleration module 210, stillness comparison server datastore 300 (as described herein at least in connection with FIG. 3), stillness comparison server module 400 (as described herein at least in connection with FIG. 4), stillness measurement module 500 (as described herein at least in connection with FIG. 5A and FIG. 5B), and/or stillness comparison module 600 (as described herein at least in connection with FIG. 6). In at least one embodiment, stillness measurement module 500 may be in user mobile device 110

In at least one embodiment, computer device memory 250 may store operating system 280. In at least one embodiment, software components such as those described herein may be loaded from a non-transient computer readable storage medium 295 into computer device memory 250 using a drive mechanism associated with a non-transient computer readable storage medium 295, such as a floppy disc, tape, DVD/CD-ROM drive, memory card, or other like storage medium. In at least one embodiment, software components such as those described herein may also be loaded via a mechanism other than a drive mechanism and computer readable storage medium 295 (e.g., via network interface 230).

In at least one embodiment, computer device memory 250 may include kernel 285, kernel space 295, user space 290, user protected address space 260, and/or stillness comparison server datastore 300 (as described herein at least in connection with FIG. 3).

In at least one embodiment, computer device memory 250 may store one or more processes 265 (i.e., executing software application(s)). In at least one embodiment, processes 265 may be stored in user space 290. In at least one embodiment, processes 265 may include one or more other process 265A . . . 265N. In at least one embodiment, one or more process 265 may execute in parallel, (i.e., as a plurality of processes and/or a plurality of threads).

In at least one embodiment, computer device memory 250 is further illustrated as storing operating system 280 and/or kernel 285. In at least one embodiment, operating system 280 and/or kernel 285 may be stored in kernel space 295. In at least one embodiment, operating system 280 may include kernel 285. In at least one embodiment, operating system 280 and/or kernel 285 may attempt to protect kernel space 295 and prevent access by one or more of process 265A . . . 265N.

In at least one embodiment, kernel 285 may be configured to provide an interface between user processes and circuitry associated with stillness comparison server 200. In at least one embodiment, kernel 285 may be configured to manage access to processor 215, chipset 255, I/O ports and peripheral devices by processes 265. In at least one embodiment, kernel 285 may include one or more drivers configured to manage and/or communicate with elements of stillness comparison server 200 (i.e., processor 215, chipset 255, I/O ports and/or peripheral devices).

In at least one embodiment, stillness comparison server 200 may comprise or communicate via bus 220 and/or via network interface 230 with stillness comparison server datastore 300, as described herein at least in connection with FIG. 3. as described herein at least in connection with, bus 220 may comprise a high-speed serial bus, and network interface 230 may be coupled to a storage area network (“SAN”), a high speed wired or wireless network, and/or via other suitable communication technology. In at least one embodiment, stillness comparison server 200 may include other components that are not illustrated in FIG. 2.

FIG. 3 is a functional block diagram of the stillness comparison server datastore 300 illustrated in the computer device of FIG. 2, according to at least one embodiment. In at least one embodiment, components of stillness comparison server datastore 300 may include data groups used by modules and/or routines (e.g., stillness user ID 305, stillness measurement 310, stillness sensor ID 315, stillness score 320, stillness event 330, stillness competition 340, and stillness event criteria 350, all as described herein). In at least one embodiment, data groups used by modules or routines illustrated in FIG. 3 may be represented by a cell in a column, or by a value separated from other values in a defined structure in a digital document or file. As may be contemplated, although data records may be referred to herein as individual records or entries, the records may comprise more than one database entry. In at least one embodiment, database entries may be, represent, or encode numbers, numerical operators, binary values, logical values, text, string operators, references to other database entries, joins, conditional logic, tests, and similar. In at least one embodiment, components of stillness comparison server datastore 300 may include other data 360 usable by modules and/or routines such as those described herein.

The components of computer datastore 300 are discussed further herein in the discussion of other of the figures described herein.

FIG. 4 is a flow diagram illustrating an example of stillness comparison server module 400 which may be in and performed by computer device(s) such as stillness comparison server 200, according to at least one embodiment. In at least one embodiment, stillness comparison server module 400 may be performed by or with the assistance of a hardware accelerator, such as hardware acceleration module 210.

In at least one embodiment, at block 405, stillness comparison server module 400 may register one or more participants. In at least one embodiment, registration may include obtaining a name, age, height, gender, contact information, location, and experience with, for example, activities understood to involve stillness. In at least one embodiment, at block 405, stillness comparison server module 400 may assign an identifier to the user or participant. In at least one embodiment, an identifier and information of the user or participant may be stored as one or more stillness user ID 305 records. In at least one embodiment, after block 405, server module 400 may advance to block 410.

In at least one embodiment, at block 410, stillness comparison server module 400 may pair the participant with a sensor device, such as stillness sensor device 105, and may assign or obtain an identifier for the paired sensor device. In at least one embodiment, an identifier may be stored as, for example, one or more stillness sensor ID 315 records. In at least one embodiment, stillness measurement module 500 may perform block 410 (i.e., stillness measurement module 500 may pair a participant with a sensor device, such as stillness sensor device 105, and may assign or obtain an identifier for the paired sensor device. In at least one embodiment, after block 410, server module 400 may advance to block 410.

In at least one embodiment, at block 415, stillness comparison server module 400 may create or obtain information regarding a stillness event. In at least one embodiment, for example, a created or obtained information may comprise an event name, date, time of start, time of finish, type of event, sponsors for the event, criteria for evaluation of the event, criteria for participation in the event, and the like. In at least one embodiment, criteria for an event may include, for example, postures, poses, expected or historic stillness results of the event, symmetry, whether participants are to be together in groups, whether group participation may increase score or rank, whether group size must fall within a minimum or maximum, disqualification criteria (if any) for an event, and the like. In at least one embodiment, certain of the created or obtained information may be stored in, for example, one or more stillness event 330 records; criteria for evaluation of the event may be stored in, for example, one or more stillness event criteria 350 records. In at least one embodiment, after block 415, server module 400 may advance to block 420.

In at least one embodiment, at block 420, stillness comparison server module 400 may publish event(s) to participants and or to the public. In at least one embodiment, after block 420, server module 400 may advance to block 425.

In at least one embodiment, at block 425, stillness comparison server module 400 may receive a participant stillness event registration. In at least one embodiment, after block 425, server module 400 may advance to block 430.

In at least one embodiment, opening loop block 430 through closing loop block 435 may iterate over events, as events become active.

In at least one embodiment, at block 500, stillness comparison server module 400 may call, perform, or receive information from one or more instances of stillness measurement module 500. In at least one embodiment, for example, if stillness comparison server module 400 receives information from one or more instances of stillness measurement module 500, all or part of such information may be stored as, for example, one or more stillness measurement 310 records as described herein at least in connection with FIG. 5. In at least one embodiment, after block 500, server module 400 may advance to block 600.

In at least one embodiment, at block 600, stillness comparison server module 400 may call or perform stillness score module 600, such as to rank or score stillness, as described herein at least in connection with FIG. 6. In at least one embodiment, after block 600 if there are no more events, server module 400 may advance to block 440.

In at least one embodiment, at block 440, stillness comparison server module 400 may publish stillness scores, awards, and the like information. In at least one embodiment, after block 440, server module 400 may advance to block 499.

In at least one embodiment, at block 499, stillness comparison server module 400 may conclude and/or return to a module and/or another calling process.

FIG. 5A is the first part 500A of a flow diagram illustrating an example of stillness measurement module 500 which may be in and performed by computer device(s) such as stillness comparison server 200 and or user mobile device 110, according to at least one embodiment. FIG. 5B is the second part 500B of a flow diagram illustrating an example of stillness measurement module 500 which may be in and performed by computer device(s) such as stillness comparison server 200 and or user mobile device 110, according to at least one embodiment. In at least one embodiment, module 500 may be performed by or with the assistance of a hardware accelerator, such as hardware acceleration module 210.

In at least one embodiment, at block 501, stillness measurement module 500 may obtain information and or criteria for a stillness event, such as from stillness comparison server module 400, (e.g. from block 420). In at least one embodiment, stillness measurement module 500 may output the event criteria on, for example, user mobile device 110. In at least one embodiment, stillness event information and/or criteria may comprise, for example, a start time, an end time, a date, a type of an event, sponsors of an event, criteria for evaluation of an event, criteria for participation in an event, postures, poses, expected or historic stillness results of an event, symmetry, whether participants are to be together in groups, whether group participation may increase score or rank, whether group size must fall within a minimum or maximum, disqualification criteria (if any) for an event, and the like. In at least one embodiment, after block 501, stillness measurement module 500 may advance to block 502.

In at least one embodiment, at block 502, if not already performed, stillness measurement module 500 may pair, for example, user mobile device 110 with a stillness sensor device 105. In at least one embodiment, after block 502, stillness measurement module 500 may advance to block 503.

In at least one embodiment, at block 503, stillness measurement module 500 may obtain participant information, such as from one or more stillness user ID 305 records, such as regarding the participant's height or other information pertinent to measuring stillness. At block 503, stillness measurement module 500 may further obtain information regarding an event type, such as whether it is seated, what postures are allowed, and the like; such information may be obtained from, for example, one or more stillness event criteria 350 records, stillness event 330 records, or the like. Depending on where measurement and filtering processes are performed, the information may be passed to a corresponding module or circuit. In at least one embodiment, after block 503, stillness measurement module 500 may advance to block 505.

In at least one embodiment, at block 505, stillness measurement module 500 may obtain location and date and or time information of, for example, user mobile device 110. Such information may be obtained from, for example, global positioning system (GPS), location services, and the like. In at least one embodiment, after block 505, stillness measurement module 500 may advance to block 515.

In at least one embodiment, at decision block 515, stillness measurement module 500 may determine whether other participants are proximate to the user of a user mobile device executing this instance of stillness measurement module 500. In at least one embodiment, a determination may be made via Bluetooth®, via WiFi, via location services, by checking with a central authority, such as stillness comparison server module 400, and the like.

In at least one embodiment, if an affirmative or equivalent determination is made at decision block 515, stillness measurement module 500 may advance to block 516. In at least one embodiment, if a negative or equivalent determination is made at decision block 515, stillness measurement module 500 may advance to block 520. In at least one embodiment, at block 516, stillness measurement module 500 may log, note, or otherwise record the proximity of other participants. In at least one embodiment, at block 516, stillness measurement module 500 may log, note, or otherwise record the proximity of other participants in a way which preserves anonymity of participants. In at least one embodiment, after block 516, stillness measurement module 500 may advance to block 520.

In at least one embodiment, at block 520, stillness measurement module 500 may receive sensor data from a stillness sensor device, such as from stillness sensor device paired with user mobile device, such as from block 502. In at least one embodiment, after block 520, stillness measurement module 500 may advance to block 525.

In at least one embodiment, at block 525, stillness measurement module 500 may filter received sensor data, such as according to a frequency, a time period, such as a start or end time of an event, an expected or allowed range, and the like. In at least one embodiment, sensor data may be filtered in a similar way in or by, for example, stillness sensor device 105. In at least one embodiment, a filter may be a bandpass filter, such as a 0.03-0.2 Hz bandpass filter, a 0.03-2.0 Hz bandpass filter, and the like. In at least one embodiment, after block 525, stillness measurement module 500 may advance to block 526.

In at least one embodiment, at decision block 526, stillness measurement module 500 may determine whether a meaningful signal from stillness sensor device 105 exceeds a noise threshold for stillness sensor device 105. In at least one embodiment, for example, if stillness sensor device 105 is too low on a torso, it may return excessive noise, such as from chest breathing, from heart rate, from incorrect sensor orientation, or the like.

In at least one embodiment, if an affirmative or equivalent determination is made at decision block 526, stillness measurement module 500 may advance to block 529 and, subsequently, may continue at block 530 (illustrated in FIG. 5B). In at least one embodiment, if a negative or equivalent determination is made at decision block 526, stillness measurement module 500 may advance to block 527. In at least one embodiment, at block 527, stillness measurement module 500 may provide a message to the user that noise from stillness sensor device 105 exceeds the meaningful signal by a threshold. In at least one embodiment, for example, a message may comprise a suggestion to reposition stillness sensor device 105 on a participant's body, such as closer to the neck, higher on the torso, or the like. In at least one embodiment, after block 527, stillness measurement module 500 may advance to block 528. In at least one embodiment, at block 528, stillness measurement module 500 may return to block 520.

In at least one embodiment, after block 529 (illustrated in FIG. 5A), stillness measurement module 500 may advance to block 530 and, subsequently, may continue at block 531. In at least one embodiment, at block 531, stillness measurement module 500 may store the filtered or received sensor data in one or more stillness measurement 310 records. In at least one embodiment, after block 531, stillness measurement module 500 may advance to block 535.

In at least one embodiment, opening loop block 535 to closing loop block 565 may iterate over one or more time periods which may be part of event criteria. In at least one embodiment, opening loop block 535 to closing loop block 565 may iterate over one or more time periods which may be part of how stillness measurement 310 records are evaluated over a range of time periods. In at least one embodiment, a range of time periods may include time periods that range from a very short time period (e.g., a sub-second time period), to longer time periods (e.g., minutes, hours, or more).

In at least one embodiment, at block 540, stillness measurement module 500 may determine a body posture of the user of the stillness sensor device. In at least one embodiment, a determination may be based, for example, on characteristic orientation or movement which occur in different body postures. In at least one embodiment, a determined body posture may be stored in, for example, one or more stillness measurement 310 records. In at least one embodiment, after block 540, stillness measurement module 500 may advance to block 545.

In at least one embodiment, at block 545, stillness measurement module 500 may determine a left-right and or front-back symmetry of a participant. In at least one embodiment, determined symmetry information may be stored in, for example, one or more stillness measurement 310 records. In at least one embodiment, after block 545, stillness measurement module 500 may advance to block 550.

In at least one embodiment, at block 550, stillness measurement module 500 may determine whether the participant is asleep or awake or whether another measurable and determinable participant status has occurred. In at least one embodiment, after block 550, stillness measurement module 500 may advance to block 555.

In at least one embodiment, at block 555, stillness measurement module 500 may store a determined participant status in one or more stillness measurement 310 records. In at least one embodiment, after block 555, stillness measurement module 500 may advance to block 560.

In at least one embodiment, at block 560, stillness measurement module 500 may determine and store other movement types. In at least one embodiment, for example, stillness measurement module 500 may determine movement types, such as breathing or respiratory rate, heart rate based on movement detected by sensors, heart rate based on respiratory rate, respiratory rate based on heart rate, movement of a torso in a left-right direction, in a forward-back direction, or in a rotational or swiveling manner, or a gross body movement (e.g., wherein the sensor data is consistent with movement of an entire body, such as standing, walking, falling, running, or the like).

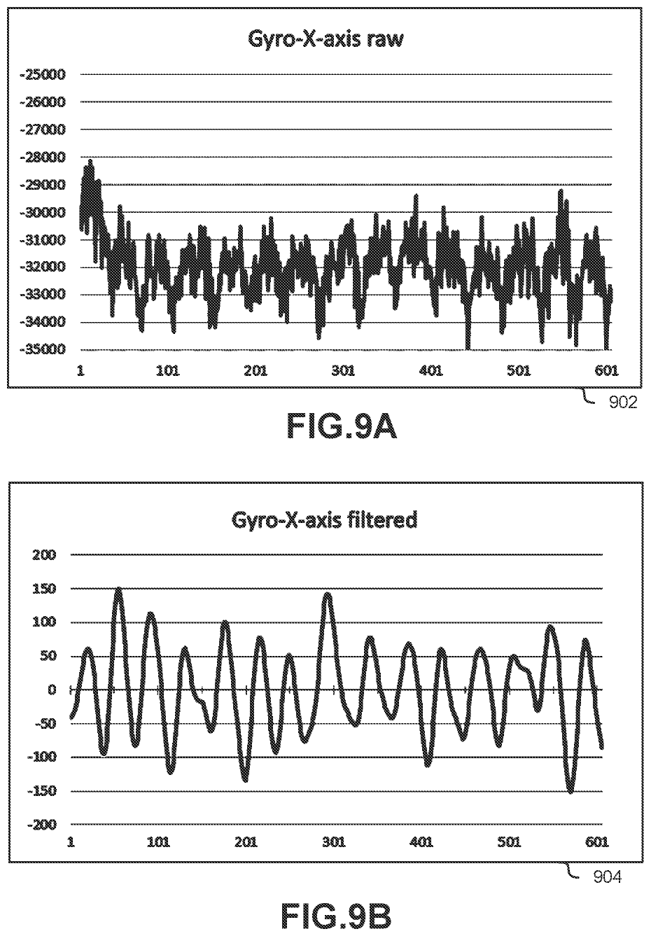

In at least one embodiment, measurement of breathing or respiratory rate may be based on registering changes of sensor orientation or sensor movement in 3-dimensional space caused by breath-induced movements of the upper thorax. In at least one embodiment, a gyroscope sensor on a torso, over an upper part of a sternum, may be a suitable place and way to measure breathing. As may be contemplated, during normal breathing, an upper sternum tends to make slight angular movements around the frontal (left-to-right) axis. Accordingly, a gyroscope sensor may detect these movements and produce a sine-like waveform with a positive half-cycle reflecting inhalation and a negative half-cycle reflecting exhalation, wherein amplitude of the gyroscope sensor signal reflects depth of breathing. For reference, a graph of an unfiltered a gyroscope signal, sampled at a rate of 10 samples per second and amplitude range of plus or minus 250 degrees per second is illustrated in FIG. 9A. A graph of an unfiltered gyroscope signal such as the graph illustrated in FIG. 9A illustrates notable noise of different origin. For reference, FIG. 9B illustrates a signal after application of a filter such as a 4-order Butterworth bandpass filter with a frequency range from 0.03 Hz to 0.32 Hz. Application of such a filter removes most of the noise and yields a cleaner respiratory signal. In at least one embodiment, a positive part of a signal illustrated in FIG. 9B may represent torso movement during inhalation while a negative part of a signal illustrated in FIG. 9B may represent torso movement during exhalation. In at least one embodiment, this described way to measure breathing may detect parts of a breath cycles (e.g., inhalation, exhalation, and breathing pauses after both inhalation and exhalation).

In at least one embodiment, a signal may be applied to measure respiratory rate and may detect (a) fiduciary time points where the signal crosses the zero line from negative to positive and (b) time points when the signal crosses the zero line from the positive to negative values. As may be contemplated, time points of the first type (type (a)) may indicate moments when a subject begins inhaling. As may also be contemplated, time points of the second type (type (b)) may indicate moments when the subject begins exhaling. In at least one embodiment, time between two consecutive fiduciary points of the same type (e.g., of type (a)) may represent the duration of one breath cycle. In at least one embodiment, a number of signal samples N between these points may be measured. In at least one embodiment, this number N multiplied by the signal sampling rate F (e.g., 10 samples per second) may give breath cycle duration T in seconds (T=N*F). In at least one embodiment, to calculate an instantaneous breathing rate, BR, measured in one breath cycle (e.g., in units of breaths per minute), sixty may be divided by the value of T (i.e., BR=60/T where “BR” is a calculated breathing rate).

In at least one embodiment, breath rate calculation may take into account that breathing at slow rates (e.g., below 5 breaths per minute) may create “false” waves of small amplitude between the real inhalation and exhalation phases. As may be contemplated, in order to reject false breath cycles, maximum and minimum peak amplitudes may be tracked and may reject fiduciary points representing false breath cycles. In at least one embodiment, fiduciary points may be tested to determine if they appear too early relative to a normal breath cycle. In at least one embodiment, therefore, amplitude and time tests for every fiduciary point may provide verification that the fiduciary points represent real breathing cycles.

As used herein, body sway is a natural process of changes in the human body's posture as a result of continuous neural control of the musculoskeletal system (MSS). As may be contemplated, a MSS is a complex structure with an extremely high number of degrees of freedom due to a large number of bones, joints and muscles. Accordingly, a tight and very complex control from brain, brain stem, and nervous system to voluntarily keep the body still is required.

As may be contemplated, sitting for a long period may cause proprioceptors in the body to signal tiredness and discomfort in muscles, tendons, joints, and bones. Accordingly, neural reflexes may cause muscles to readjust to keep posture and to relieve discomfort, which may generate body sway.

As may be contemplated, when a subject sits, the upper part of the body may make sway movements like a pendulum. In at least one embodiment, measured amplitude of sway may increase with distance of a part of the body from a base on which the subject sits. In at least one embodiment, a sensing device may be positioned at a highest possible point on a torso which is also capable of registering breathing activity (e.g., the sensing device may be positioned on an upper part of a sternum). In at least one embodiment, a mechanical design of the sensing device may prevent free movement of the sensing device caused by gravity (e.g., sensor device 105).

As may be contemplated, body sway may be three-dimensional. In at least one embodiment, body sway may be represented by a model of a pendulum with a constant distance between the pendulum anchor point (at the bottom of a sitting subject) and the head of the pendulum where the sensor is positioned on the body. In at least one embodiment, a pendulum may move in both frontal (left-to-right) and sagittal (front-to-back) directions. In at least one embodiment, such a complex movement may form a hemisphere due to the property that the radius of a pendulum is constant.

In at least one embodiment, total amount of sway in this model represents the sum of all paths made by the arrowhead of the pendulum vector in the hemisphere space. In at least one embodiment, total amount of sway can be split into two orthogonal projections on the frontal and sagittal planes. In at least one embodiment, changes in both planes can be accurately described in polar coordinates (constant radius R and the angle of deflection from the vertical line). In at least one embodiment, a model registers angular changes in both frontal and sagittal planes and calculates a linear path increment that a head of a pendulum travels across a hemisphere surface. In at least one embodiment, linear path increments may be calculated by conversion from polar to Cartesian coordinates. In at least one embodiment, an amount of sway may be calculated as a sum of linear path increments in both planes.

In at least one embodiment, sway measurement may be performed using, for example, a 3-axis accelerometer sensor and or a gyroscope, including a micromechanical system (MEMS) gyroscope. In at least one embodiment, an accelerometer may measure linear acceleration in three orthogonal planes in milligravities. In at least one embodiment, double-integration of a measured signal over time may produce a linear path in both coordinate planes. In at least one embodiment, a gyroscope may measure rotation in one or more axis.

As described herein, at block 405 of FIG. 4, a participant's height may be obtained. In at least one embodiment, an obtained height may be used to scale a model (a length of a pendulum) to determine a sway/stillness score. In at least one embodiment, obtained information may be uploaded to stillness sensor device 105 after pairing or may be used by a computer performing stillness measurement module 500 with respect to a particular participant.

In at least one embodiment, additional degrees of freedom can be added to a model to better approximate ranges of motion (ROM) available within a participant's spine. In at least one embodiment, a model may still retain the polar co-ordinate system but may add additional linkages with constrained ROMs to represent physical limitations of a human body. In at least one embodiment, a constrained model may be used to generate an improved understanding of forward and reverse kinematics and may allow improved isolation of noise from true signals.

### Sway and Breathing Combination

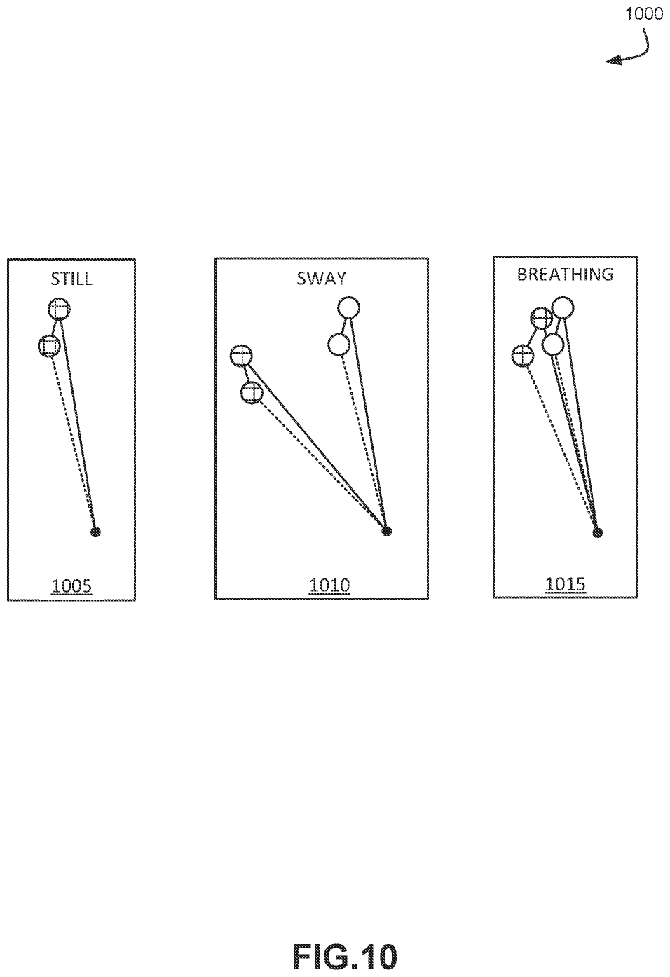

As may be contemplated, using a combined accelerometer and gyroscopic sensor on the upper part of the sternum to measure sway and breathing may present significant difficulties. For example, it may be hard to distinguish movements in the sternum caused by breathing from movements in the sternum caused by body sway because physical properties of movements from both origins may be similar in both time and frequency domains. In at least one embodiment, a solution may be obtained by modelling two interconnected pendulums. In at least one embodiment, a first pendulum may represent body sway. In at least one embodiment, a first pendulum may have an anchor point at the bottom of sitting and the gyroscope and accelerometer sensors at the pendulum head. In at least one embodiment, a second pendulum may be set in the opposite direction, with anchor point attached to the head point of a first pendulum. In at least one embodiment, a head of a second pendulum may be pointed down toward the lower part of a participant's sternum and have gyroscope and accelerometer sensors on it. In at least one embodiment, a length of the second pendulum may be long enough to achieve sensitivity to discriminate movements of breathing and body sway origin. In at least one embodiment, such a model may be based on an assumption that breathing causes the chest to expand differently at different points. Accordingly, expansion movement at the head of the second pendulum may be greater than the head of the first pendulum. In at least one embodiment, when there is body sway and no breathing, heads of both pendulums may turn to the same angle relative to the anchor of a first pendulum, so distances travelled are proportional to their respective radiuses. FIG. 10 illustrates such pendulums.

In at least one embodiment, angular difference between heads of pendulums may be a signal of breathing while change in an angle of the first radius may predominantly reflect body sway.

In at least one embodiment, a head of a second pendulum (with a gyroscope and accelerometer sensor) may be located on a body in an area relatively isolated from the breathing movements (e.g., on back side of the neck).

In at least one embodiment, measurements may be based on one or more assumptions including, but not limited to, (a) a subject tries to sit still in an upright position, (b) stillness sensor device 105 may be secured on or close to the neck (for example, as a bolo-tie) thereby limiting its free movement, and (c) thoracic breathing is present. In at least one embodiment, with such assumptions, a stillness sensor device 105 may detect changes in acceleration and incline that are associated with breathing movements dominating over movements of different origin. In at least one embodiment, stillness sensor device 105 may produce one or more wave-like periodic signal(s) with a stable pattern that may be analyzed in time-domain space. In at least one embodiment, such analysis may provide measurement of respiratory rate breath-by-breath with, for example, 100-millisecond accuracy. In at least one embodiment, such analysis may allow detecting breath cycle phases such as inhalation, exhalation and pauses.

In at least one embodiment, at closing loop block 565, stillness measurement module 500 may return to opening loop block 535 to iterate over another time period. In at least one embodiment, when there are no more time periods, after block 565, stillness measurement module 500 may advance to block 570.

In at least one embodiment, at block 570, stillness measurement module 500 may report the obtained information to, for example stillness comparison server module 400. In at least one embodiment, after block 570, stillness measurement module 500 may advance to block 599.

In at least one embodiment, at block 599, stillness measurement module 500 may return, conclude and/or may return to a process which may have spawned or called it.

FIG. 6 is a flow diagram illustrating an example of stillness score module 600 which may be in and performed by computer device(s) such as stillness comparison server 200, according to at least one embodiment. In at least one embodiment, stillness score module 600 may be performed by or with the assistance of a hardware accelerator, such as hardware acceleration module 210.

In at least one embodiment, opening loop block 605 to closing loop block 655 may iterate over a stillness event, such as one with a stillness event 330 record. In at least one embodiment, after block 605, stillness score module 600 may advance to block 610.

In at least one embodiment, at block 610, stillness score module 600 may obtain event criteria for an event of opening loop block 605 to closing loop block 655, such as from one or more stillness event criteria 350 records. In at least one embodiment, after block 610, stillness score module 600 may advance to block 615.

In at least one embodiment, at block 615, stillness score module 600 may obtain stillness measurements from participants, such as from stillness measurement module 500 and or from one or more stillness measurement 310 records. The participants may be or have been registered or enrolled in the then-current event. In at least one embodiment, after block 615, stillness score module 600 may advance to block 620.

In at least one embodiment, opening loop block 620 to closing loop block 635 may iterate over participants registered or enrolled in the then-current event. In at least one embodiment, after block 620, stillness score module 600 may advance to block 625.

In at least one embodiment, at decision block 625, stillness score module 600 may determine if a disqualification occurred in relation to the then-current participant. In at least one embodiment, for example, disqualification may occur if a participant fell asleep, is engaged in a posture or position not allowed under the stillness event criteria, was or was not present with other participants, or the like.

In at least one embodiment, if an affirmative or equivalent determination is made at decision block 625, stillness score module 600 may advance to block 630. In at least one embodiment, if a negative or equivalent determination is made at decision block 625, stillness score module 600 may advance to block 635. In at least one embodiment, at block 630, stillness score module 600 may remove, flag, or otherwise disqualify the participant from the then-current stillness event. In at least one embodiment, after block 630, stillness score module 600 may advance to block 631.

In at least one embodiment, at block 631, stillness score module 600 may determine a score for a participant in an event. In at least one embodiment, a score may be a product of processing stillness measurements from participants. In at least one embodiment, such processing may comprise weighting different types of movements, a participant's posture, a participant's pose, or the like.

In at least one embodiment, at closing loop block 635, stillness score module 600 may return to opening loop block 620 to iterate over other participants in the stillness event. In at least one embodiment, if there are no more participants, after closing loop block 635, stillness score module 600 may advance to block 640.

In at least one embodiment, at block 640, stillness score module 600 may weigh different stillness measurements or other stillness output in relation to a stillness event. In at least one embodiment, for example, one or more different time periods within a stillness event may be weighted differently, different poses, postures, or determined movement types may be weighted differently, presence or absence of people in a location may be weighted differently, and the like. In at least one embodiment, after block 640, stillness score module 600 may advance to block 645.

In at least one embodiment, at block 645, stillness score module 600 may compare, score or rank participants in the stillness event, such as according to the stillness measurements of block 615, individual participant scores of block 631, and or weighted stillness measurements of block 640. In at least one embodiment, after block 645, stillness score module 600 may advance to block 650.

In at least one embodiment, at block 650, stillness score module 600 may report a score or rank of participants in the stillness event, such as to the participants, to the public, to sponsors, or the like. In at least one embodiment, after block 650, stillness score module 600 may advance to block 655.

In at least one embodiment, at closing loop block 655, stillness score module 600 may return to opening loop block 610 to iterate over other stillness events. In at least one embodiment, if there are no more events, after closing loop block 655, stillness score module 600 may advance to block 699.

In at least one embodiment, at block 699, stillness score module 600 may return, conclude and/or may return to a process which may have spawned or called it.

FIG. 7 illustrates an example 700 of stillness sensor device 105, according to an embodiment. In at least one embodiment, stillness sensor device 105 comprises lanyard 705 and sensor unit 710. In at least one embodiment, a position of sensor unit 710 along lanyard 705 may be adjustable. In at least one embodiment, a participant may be encouraged to place sensor unit 710 in a preferred area on the participant's body and/or in a preferred configuration relative to clothing of a participant, such as on top of clothing or beneath clothing. In at least one embodiment, stillness measurement module 500 may determine whether a meaningful signal exceeds a noise threshold for stillness sensor device 105. In at least one embodiment; when a meaningful signal does not exceed a noise threshold for stillness sensor device 105, stillness measurement module 500 may inform a participant and provide a recommendation, such as to move stillness sensor device 105 higher on a torso or the like.

FIG. 8 illustrates an example 800 of a portion of stillness sensor device 105 in an exploded format to show components thereof, according to an embodiment.

In at least one embodiment, stillness sensor device 105 comprises front enclosure 805, battery 810, printed circuit board (“PCB”) 815, back enclosure 820, spring 825, and button 830.

In at least one embodiment, PCB 815 may comprise sensors discussed herein. In at least one embodiment, such sensors may include, for example, accelerometer, gyroscopes, temperature, GPS, and the like, which may be used to obtain stillness measurements discussed herein. In at least one embodiment, a type, sensitivity, axis orientation, and bitrate or bit resolution mode of sensors is selected so as to return a meaningful signal, notwithstanding sensor noise. In at least one embodiment, for example, a sensor may produce noise that is comparable with a signal recorded while a participant is sitting still. In at least one embodiment, such noise may not be acceptable, inasmuch as a goal may be to compare and score participants based on ability to sit still, with potentially subtle differences between participants. In at least one embodiment, for example, a gyroscopic sensor with a range of angular speed not greater than approximately 60 degrees per second and a 12-bit resolution may be used, inasmuch as a commonly available gyroscopic sensor with a range of angular speed of approximately 250 degrees per second and 12-bit resolution may be characterized as having a sensitivity of 0.125 degrees per second per 1 bit, which may produce noise up to four least significant bits, which may be greater than a defined 2 bit threshold of acceptability.

In at least one embodiment, PCB 815 may further comprise communication equipment, including BLUETOOTH®, WiFi, and the like for connection with, for example, one or more user mobile device 110 and modules therein, with stillness comparison server 200 and modules therein, and the like. In at least one embodiment, PCB 815 may further comprise computer memory and processor devices, similar to those discussed herein in relation to stillness comparison server 200. In at least one embodiment, PCB 815 may comprise, for example, processing units, hardware acceleration module, input and output hardware and interfaces thereto (including audio, visual, haptic and other input and output), a network interface, and memory. In at least one embodiment, memory in PCB 815 may comprise modules enabling functions of sensor device 105 discussed herein.

In at least one embodiment, button 830 may be used as an input or output for stillness sensor device 105, such as to turn stillness sensor device 105 on or off, to pair stillness sensor device 105 with a user mobile device 110, to upload or transmit data to another computer device or module, and the like.

FIG. 9A illustrates a graph 902 of a sample of unfiltered sensor data, according to at least one embodiment. Graph 902 of a sample of unfiltered sensor data is described in more detail herein at least in connection with FIG. 5.

FIG. 9B illustrates a graph 904 of a sample of filtered sensor data, according to at least one embodiment. Graph 904 of a sample of filtered sensor data is described in more detail herein at least in connection with FIG. 5.

FIG. 10 illustrates examples 1000 of movements of one or more sensors according to at least one embodiment Pendulum 1005, pendulum 1010, and pendulum 1015 are described in more detail herein at least in connection with FIG. 5.

FIG. 11 illustrates an example environment 1100 in which various embodiments can be implemented, in accordance with at least one embodiment. FIG. 11 illustrates an example computing device 1102 that may be used to implement one or more embodiments, in accordance with the present disclosure. In a basic configuration 1104, an example computing device 1102 may include one or more processors 1110 and may include memory such as system memory 1120. A memory bus 1130 may be used for communicating between a processor 1110 of the computing device 1102 and the system memory 1120. The computing device 1102 may include any appropriate device operable to send and/or receive requests, messages, or information over an appropriate network and may, in some embodiments, convey information back to a user of the computing device in response to such requests. Examples of such computing devices include personal computers, cell phones, handheld messaging devices, laptop computers, tablet computers, set-top boxes, personal data assistants, mobile devices, wearable devices, embedded computer systems, electronic book readers, application specific client devices and the like. The network may include any appropriate network, including an intranet, the Internet, a cellular network, a local area network, a satellite network or any other such network and/or combination thereof. Communication over the network can be enabled by wired or wireless connections and combinations thereof.

The information (also referred to herein as “content”) conveyed back to the user of the computing device 1102 may include, but may not be limited to, text, graphics, audio, video, and/or other content usable to be provided to the user. The information conveyed back to the user of the computing device may be conveyed in the form of HyperText Markup Language (“HTML”), Extensible Markup Language (“XML”), JavaScript, Cascading Style Sheets (“CSS”), or some other such client-side structured language. Content may be processed by the computing device 1102 to provide the content to the user of the computing device 1102 in one or more forms including, but not limited to, forms that are perceptible to the user audibly, visually and/or through other senses including touch, taste, and/or smell. Requests and responses sent over the network may be handled by a server using PUP: Hypertext Preprocessor (“PUP”), Python, Ruby, Perl, Java, HTML, XML, or another appropriate server-side structured language. It should be understood that operations described herein as being performed by a single device may, unless otherwise clear from context, be performed collectively by multiple devices.

In some embodiments, the processor 1110 may be of a type including but not limited to a microprocessor, a microcontroller, a digital signal processor (DSP), or any combination thereof. A processor 1110 may include one or more levels of caching, such as a level one (L1) cache 1111 and a level two (L2) cache 1112. A processor may also include a processor core 1113, and registers 1114. The processor core 1113 may include, for example, an arithmetic logic unit (ALU), a floating-point unit (FPU), a digital signal processing core (DSP Core), a graphics processing unit (GPU) or a combination of these and/or other such processing units. A memory controller 1115 may also be used with the processor 1110 to control the memory such as the system memory 1120. In some implementations the memory controller 1115 may be an internal part of the processor 1110.

In some embodiments, the system memory 1120 may be of any type including but not limited to volatile memory (such as RAM), non-volatile memory (such as ROM, flash memory, etc.) or any combination thereof. System memory 1120 may contain an operating system 1121, one or more applications 1122, and program data 1124 associated with such applications 1122. An application 1122 may include a component 1123 configured for sharing applications between mobile devices in a peer-to-peer environment, in accordance with the present disclosure. The program Data 1124 may include applicant or organizational data 1125 as described herein. In some embodiments, application 1122 can be arranged to operate with program data 1124 on an operating system 1121 such that operation of a system may be facilitated on general purpose computer systems.

A computing device 1102 can have additional features or functionality, and additional interfaces to facilitate communications between the basic configuration 1104 and any required devices and interfaces. For example, a bus/interface controller 1140 can be used to facilitate communications between the basic configuration 1104 and one or more data storage devices 1150 via a storage interface bus 1141. The data storage devices 1150 can be removable storage devices 1151, non-removable storage devices 1152, or a combination thereof. Examples of removable storage and non-removable storage devices include magnetic disk devices such as flexible disk drives and hard-disk drives (HOD), optical disk drives such as compact disk (CD) drives or digital versatile disk (DVD) drives, solid state drives (SSD), and tape drives and/or other such storage devices. Examples of computer storage media may include volatile and nonvolatile, removable, and non-removable media implemented in any method or technology for storage of information, such as computer readable instructions, data structures, program modules, or other data.

System memory 1120, removable storage device 1151, and non-removable storage device 1152 are all examples of computer storage media. Computer storage media (or computer-readable medium) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 1102. Any such computer storage media can be part of device 1102.

Computing device 1102 may also include an interface bus 1142 for facilitating communication from various interface devices (e.g., output interfaces, peripheral interfaces, and communication interfaces) to the basic configuration 1104 via the bus/interface controller 1140. Example output devices 1160 include a graphics processing unit 1161 and an audio processing unit 1162, which can be configured to communicate to various other computing devices 1192 (such as a display or speakers) via one or more audio/visual ports 1163. Example peripheral interfaces 1170 include a serial interface controller 1171 or a parallel interface controller 1172, which can be configured to communicate with other computing devices 1194 such as input devices (e.g., keyboard, mouse, pen, voice input device, touch input device, etc.) or other peripheral devices (e.g., printer, scanner, etc.) via one or more I/O ports 1173.

An example communication device 1180 may include a network controller 1181, which can be arranged to facilitate communications with one or more other computing devices 1190 over a network communication via one or more communication ports 1182. Communication ports 1182 may further include components configured to communicate over a near-area network. Examples of such communication ports 1182 may utilize at least one network for supporting communications using any of a variety of protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”) and Common Internet File System (“CIFS”). The network can be, for example, a local area network, a wide-area network, a virtual private network, the Internet, an intranet, an extranet, a public switched telephone network, an infrared network, a wireless network, a satellite network, and any combination thereof.

A computing device 1102 may be implemented as a computer such as a laptop computer, a personal computer, a workstation, a server or some other such computer device. A computing device 1102 may also be implemented as a portable (or mobile) computer such as a cell phone, a personal data assistant (PDA), a personal media player device, a wireless web-watch device, a personal headset device, an application specific device, or some other such device. A computing device may also be implemented as a combination of computer and/or portable devices including, but not limited to, the devices described herein. A computing device 1102 may include an operating system that may provide executable program instructions for the general administration and operation of that device and may include a computer-readable storage medium (e.g., a hard disk, random access memory, read only memory, etc.) storing instructions that, when executed by a processor of the device, allow the device to perform its intended functions.

The computing device 1102 illustrated in the example environment 1100 may be part of a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 11. Thus, the depiction of the system illustrated in FIG. 11 should be taken as being illustrative in nature and not limiting to the scope of the disclosure. The various embodiments may also be implemented in a wide variety of operating environments, which in some cases can include one or more computers and/or computing devices that may be used to operate any number of applications. Such devices may include any of a number of general-purpose personal computers, such as desktop, laptop or tablet computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, application specific devices and other devices capable of communicating via a network. These devices also can include virtual devices such as virtual machines and other such virtual devices capable of communicating via a network.

Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings herein are to be regarded in an illustrative rather than a restrictive sense. It will, however, be evident that various modifications and changes may be made thereunto without departing from the broader spirit and scope of the invention as set forth in the claims.

Other variations are within the spirit, and therefore scope, of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions. USB (Universal serial bus) may comply or be compatible with Universal Serial Bus Specification, Revision 2.0, published by the Universal Serial Bus organization, Apr. 27, 2000, and/or later versions of this specification, for example, Universal Serial Bus Specification, Revision 3.1, published Jul. 26, 2013. PCIe may comply or be compatible with PCI Express 3.0 Base specification, Revision 3.0, published by Peripheral Component Interconnect Special Interest Group (PCI-SIG), November 2010, and/or later and/or related versions of this specification.

As used herein, “social network service” is an online platform used by humans and organization to build social networks or social relations among humans and organizations who share similar personal or career interests, activities, backgrounds, or real-life connections.

As used in any embodiment herein, the term “logic” may refer to the logic of the instructions of an app, software, and/or firmware, and/or the logic embodied into a programmable circuitry by a configuration bit stream, to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as FPGA. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high-speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module or be split among several modules. The components may be processes running on, or implemented on, a single compute node or distributed among a plurality of compute nodes running in parallel, concurrently, sequentially or a combination, as described more fully in conjunction with the flow diagrams in the figures.

As used herein, a process corresponds to an instance of a program, e.g., an application program, executing on a processor and a thread corresponds to a portion of the process. A processor may include one or more execution core(s). The processor may be configured as one or more socket(s) that may each include one or more execution core(s).

As used herein “releasable”, “connect”, “connected”, “connectable”, “disconnect”, “disconnected,” and “disconnectable” refers to two or more structures which may be connected or disconnected, generally without the use of tools (examples of tools including screwdrivers, pliers, drills, saws, welding machines, torches, irons, and other heat sources) or with the use of tools but in a repeatable manner (such as through the use of nuts and bolts or screws). As used herein, “attach,” “attached,” or “attachable” refers to two or more structures or components which are attached through the use of tools or chemical or physical bonding, but wherein the structures or components may not generally be released or re-attached in a repeatable manner. As used herein, “secure,” “secured,” or “securable” refers to two or more structures or components which are connected or attached.

What is claimed is:

1. A computer implemented method comprising:
obtaining one or more stillness metrics associated with a stillness event;
initiating the stillness event;
collecting one or more stillness measurements during the stillness event, wherein the one or more stillness measurements are based at least in part on the one or more stillness metrics;
developing a stillness score for a participant in the stillness event, based at least in part on the one or more stillness measurements; and
reporting the stillness score.

2. The computer implemented method of claim 1, further comprising:
reporting an intermediate stillness score determined during the stillness event.

3. The computer implemented method of claim 1, wherein:
the stillness measurements include one or more measurements of the participant's body posture.

4. The computer implemented method of claim 1, wherein:
the stillness measurements include a measurement of a left-right symmetry of the participant.

5. The computer implemented method of claim 1, wherein:
the stillness measurements include a measurement of a front-back symmetry of the participant.

6. The computer implemented method of claim 1, wherein:
the one or more stillness metrics are collected using a stillness sensor device.

7. The computer implemented method of claim 1, further comprising:
determining a ranking for the participant, based at least in part on one or more stillness scores of one or more other participants in the stillness event; and
reporting the ranking.

8. A computer system comprising one or more processors and memory storing executable instructions that, as a result of being executed by the one or more processors, cause the computer system to:
obtain a stillness metric associated with a stillness event;
collect one or more stillness measurements during the stillness event, wherein the one or more stillness measurements are based at least in part on the stillness metric; and
store a stillness score for a participant in the stillness event, wherein the stillness score is based at least in part on the one or more stillness measurements.

9. The computer system of claim 8, wherein the one or more stillness measurements are collected using a stillness sensor device.

10. The computer system of claim 8, wherein the stillness metric is obtained from a stillness comparison server.

11. The computer system of claim 8, wherein the stillness score is stored in a stillness comparison server datastore.

12. The computer system of claim 8, wherein the one or more stillness measurements are collected using a wearable device.

13. The computer system of claim 12, wherein the wearable device is paired to a mobile device of the participant.

14. The computer system of claim 8, wherein the one or more stillness measurements include a sleep status of the participant.

15. A machine-readable medium having stored thereon a set of instructions, which if performed by one or more processors, cause the one or more processors to:
collect one or more stillness measurements during a stillness event, wherein the one or more stillness measurements are based at least in part on a stillness metric associated with the stillness event; and
store a stillness score for a participant in the stillness event, wherein the stillness score is based at least in part on the one or more stillness measurements.

16. The machine-readable medium of claim 15, wherein the set of instructions further comprise instructions which, if executed by the one or more processors, cause the one or more processors to:
register the participant for notifications of stillness events; and
receive notification of stillness events from a stillness comparison server.

17. The machine-readable medium of claim 15, wherein the stillness score is based at least in part on a weighted combination of the one or more stillness measurements.

18. The machine-readable medium of claim 15, wherein:
the participant is disqualified from the stillness event based at least in part on the one or more stillness measurements; and
the stillness score of the disqualified participant is not stored.

19. The machine-readable medium of claim 15, wherein the one or more stillness measurements are reported to a stillness comparison server module.

20. The machine-readable medium of claim 15, wherein the stillness score is computed by a stillness score module.
